(19) United States
(12) Patent Application Publication
(10) Pub. No.: US 2009/0090687 A1
(43) Pub. Date: Apr. 9, 2009

(54) Hydraulic Cylinder

(75) Inventors: Johann Schabelreiter, Pernegg (AT); Herbert Marquardt, St. Stefan (AT); Horst Joebstl, St. Stefan (AT)

Correspondence Address: SHERIDAN ROSS PC, 1560 BROADWAY, SUITE 1200, DENVER, CO, 80202, US

(73) Assignee: SCHWING GMBH, St. Stefan (AT)

(21) Appl. No.: 12/093,897

(22) PCT Filed: Oct. 26, 2006
(86) PCT No.: PCT/EP2006/010350

§ 371 Date: Sep. 3, 2008

(30) Foreign Application Priority Data
Nov. 17, 2005 (AT) A1874/2005

(51) Int. Cl. B66C 23/00; F04B 53/00

(52) U.S. Cl. 212/347; 92/169.1

(57) ABSTRACT

In a hydraulic cylinder for a multiple-part mast superstructure comprising at least two mast arms which are connected in an articulated manner and of which one can be pivoted with respect to the other mast arm by the hydraulic cylinder, it is proposed that the base region of the cylinder container is of curved configuration, which cylinder container is closed in the base region on one side in order to accommodate a piston. In this way, the force flux is improved in the walls of the hydraulic cylinder, with the result that manufacturing which uses less material and is correspondingly less expensive is possible, with a simultaneously reduced overall weight. The hydraulic cylinder in accordance with the invention is suitable, in particular, for use with concrete pumps, cranes, lifting platforms and the like or general apparatuses having mast superstructures, in which hydraulic cylinders are used for pivoting.

The present invention relates to a hydraulic cylinder for a multiple part mast superstructure comprising at least two mast arms, which are connected in an articulated manner and of which one can be pivoted with respect to the other mast arm by the hydraulic cylinder, especially for concrete pumps, cranes, lifting platforms and the like, with a cylinder container closed on one side in the base region in order to accommodate a piston.

Furthermore, the present invention relates to a device with mast superstructure with at least two mast arms connected in an articulated manner, one of which may be pivoted relative to the other mast arm by a hydraulic cylinder, especially for concrete pumps, cranes, lifting platforms and the like.

So-called mast superstructures comprising a plurality of pairs of mast arms connected in an articulated manner are used in the construction industry to convey flowable building materials, such as concrete, from a central point of delivery to virtually any processing location within reach of the mast superstructure. To be able to change the geometry of such a mast superstructure, pairs of mast arms of the mast superstructure are joined to each other in an articulated manner and may be pivoted against each other by a hydraulic cylinder.

From a statics point of view, the hydraulic cylinder machine is a pressure vessel of variable geometry for transmitting and accommodating forces. In general, the housing of the hydraulic cylinder, hereinafter also referred to as a cylinder container, is formed from a (cylinder) pipe with welded-on base piece. The base piece usually consists of a solid cylinder with a cross-hole for a bearing bolt, which is provided for mounting the hydraulic cylinder to one of the mast arms. Alternatively, the base piece can also be configured as a disc with welded-on cross-pipe configured as a bearing bolt. Depending on the intended use of the hydraulic cylinder, the corresponding bolt eye has a narrow configuration and is fitted with a swing bearing, or it attains the width of the container or extends over the side thereof. For heavy-duty lightweight cylinders, the base piece is welded in the highest possible quality to the cylinder pipe as a carefully machined disc. The bearing bolt is also connected to the base piece disc in an elaborate manner. Configuring the base piece as a cast steel piece improves the stability properties of the solution described above.

From the point of view of the force flux, the aforementioned closure of a (circular) cylinder container, which is under internal pressure, with a disc or flat, that is, planar base part is intensive in terms of weight and notches for reasons of force accommodation and support. To avoid associated disadvantages, previously known hydraulic cylinders provide for elaborate weld seam preparations and reliefs, with the result that such hydraulic cylinders consume a lot of material in manufacture and are correspondingly expensive.

The object of the invention is, by avoiding the above-mentioned disadvantages, to create a hydraulic cylinder which, on account of improved force flux, can be produced with less material and thus overall reduced weight, while offering at least the same or improved stability. Furthermore, the object of the invention is to create a device with a mast superstructure, which, relative to the known device of this kind, is characterized particularly by a lower overall weight and improved movement and stability properties.

The object is achieved in a hydraulic cylinder of the kind mentioned at the outset by forming the base region of the cylinder container so as to have a curved configuration.

In a device having a mast superstructure of the kind mentioned at the outset, the object is achieved by the device's having at least one inventive hydraulic cylinder for pivoting the mast arms.

Accordingly, the basic idea of the inventive solution is to replace the base piece of the hydraulic cylinder, which traditionally usually has a disc configuration, with a curved shell, with especially a hemisphere shape constituting the optimum shape from a statics point of view and accordingly requiring the thinnest wall thickness combined with maximum weight reduction.

In this context, a preferred embodiment of the inventive hydraulic cylinder provides that the base region be concave with respect to the cylinder container, i.e. curved outwards, so as to yield a particularly advantageous force flux. Alternatively, however, in a further development of the inventive hydraulic cylinder, the base region can be provided in a convex configuration with respect to the cylinder container, i.e. curved inwards.

To achieve uniform loading in the base region of the cylinder container, provision can furthermore be made in an inventive hydraulic cylinder for the cross-section of the base region to have a uniform curvature, with the base region of a particularly preferred embodiment of the inventive hydraulic cylinder having a spherical cross-section, especially in the form of a hemispherical shell.

Alternatively, it is also possible to configure the hydraulic cylinder in the base region of the cylinder container so as to have a curvature of non-uniform cross-section. A further embodiment of the inventive hydraulic cylinder provides for the base region of the cylinder container to have a parabolic configuration.

In order to furthermore attain the most uniform-possible loading of the base region of the inventive hydraulic cylinder, provision can be made in a further embodiment of the inventive hydraulic cylinder for the cross-section of the base region to be symmetrical with respect to a longitudinal axis of the cylinder container.

If the inventive hydraulic cylinder is to be used for the purpose of a known mast arm structure, it will be necessary to provide a bearing eye in the form of an eye part, i.e. a part with at least one such bearing eye, in the base region of the cylinder container. In order that, in this context, to achieve load-bearing capacity of the base region of the cylinder container through increasing the wall thickness, while retaining the curved shape, a particularly preferred embodiment of the inventive hydraulic cylinder provides for the inside of the base region to be configured as a spherical segment, especially a hemisphere, and for the outside to have a parabolic configuration, as a result of which the desired increase in wall thickness is achieved, especially in the crown area of the curve, such that a bearing eye (eye part) can preferably be arranged there.

In a further development of such an embodiment of the inventive hydraulic cylinder, it is possible especially to configure the eye part as a narrow rib having a swing bearing, as a result of which maximum movement of the hydraulic cylinder relative to the mast arms is created.

In accordance with another advantageous embodiment of the inventive hydraulic cylinder, the cylinder pipe for outwardly transmitting reaction or bearing forces can be extended beyond the curved base region, with the bearing eyes for the bearing bolts capable of using the extra space gained thereby to mount the hydraulic cylinder to one of the mast arms. To this end, accordingly, in an inventive further embodiment of the hydraulic cylinder, provision is made for the eye part to be configured as a ring part that extends the cylinder container beyond the base region, the casing of said ring part having two oppositely arranged eye openings for accommodating at least one mounting pin. In accordance with the invention, there is accordingly the possibility of using either a split bolt with multi-point connection or a continuous bolt with two-point connection.

Where the base region is concave, the above-described extension of the cylinder container beyond the base region is obtained by attaching an additional ring part, while, in contrast, a convex curvature of the base region or the corresponding base piece itself can be extended beyond the cylinder container, such that no further ring part is to be provided.

Given a significant reduction in the total weight of the inventive hydraulic cylinder with respect to conventional cylinder designs, a mounting bolt guided outside the pressure area of the hydraulic cylinder requires a relatively large dead length in the base region of the cylinder, however. If, however, corresponding space for installation of the hydraulic cylinder is available, the bolt eye can also be placed in and penetrate the pressure area of the hydraulic cylinder. A corresponding preferred embodiment of the inventive hydraulic cylinder therefore provides for the eye part to be shaped as a bearing-bolt pipe pushed through the cylinder container.

In order that the available working volume of the hydraulic cylinder may not be impaired, a further embodiment of the inventive hydraulic cylinder provides for the bearing-bolt pipe to be arranged inside a volume defined by the base region.

A further embodiment of the inventive hydraulic cylinder can provide for the bearing-bolt pipe to touch the base region of the cylinder container, i.e. a wall of the cylinder container. In the course of such an embodiment, the base region of the cylinder container can be configured as a one-piece cast part having improved stability properties.

Alternatively, in a further embodiment of the inventive hydraulic cylinder, it is also possible for the bearing-bolt pipe to be arranged at a distance from the base region of the cylinder container. Such a design has the advantage that, even after the cylinder container has been made, the bearing-bolt pipe can be subsequently inserted into it by opening its two sides.

As mentioned above, the base region and the bearing-bolt pipe can be configured as one joint piece, especially as a cast part. The connection of this cast part to a cylinder pipe to form a cylinder container is made by a ring-shaped weld seam. The necessary seam preparation includes the configuration of the necessary weld pool backing of the weld seam. By means of the inventive favorable force flux, it is possible to either retain the weld pool backing or, by means of an additional stress-relieving notch, which is produced in one working step with the weld seam preparation, to further relieve it. In this way, an additional, costly working operation is saved in the course of the present invention, without compromising the quality of the resultant part.

Furthermore, through the provision of the above-mentioned penetrating pipe for the bolt (pin pipe), it is possible in an inventive hydraulic cylinder to place the piston stop in an area of favorable load. For this, an extremely preferred embodiment of the inventive hydraulic cylinder provides for the bearing-bolt pipe to be provided with a stop for the piston.

Additional properties and advantages of the present invention arise from the following description of embodiments using the drawing. These show in:

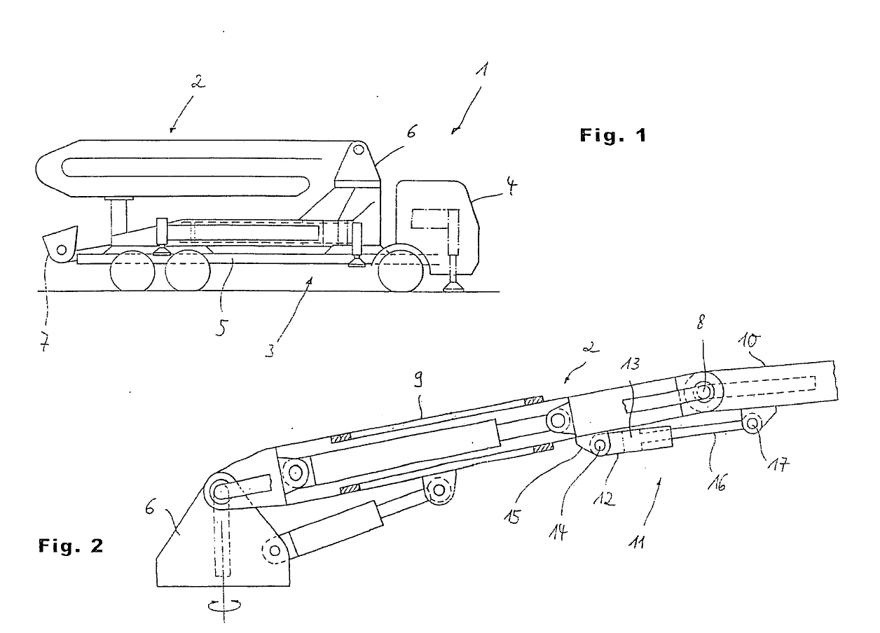

FIG. 1A schematic overall view of an inventive device with mast superstructure in the embodiment of a concrete-pumping vehicle;

FIG. 2 A schematic partial view of the mast superstructure of the concrete pump from FIG. 1;

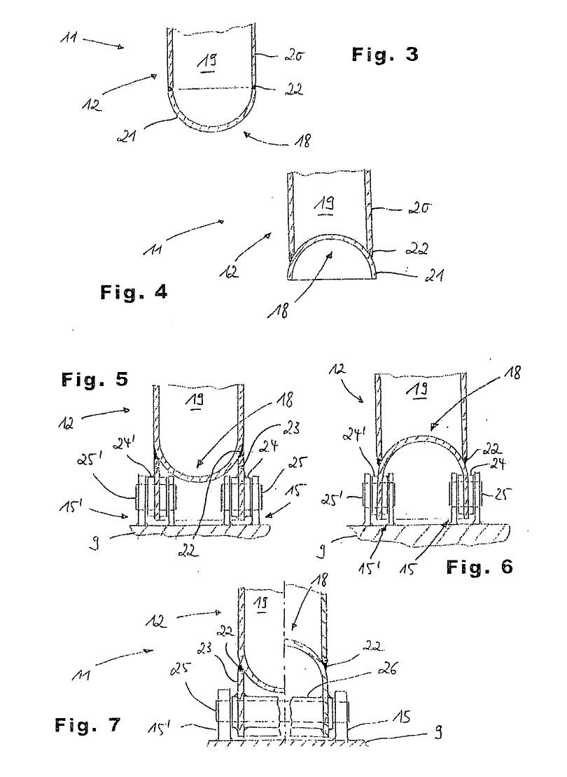

FIG. 3 A partial cross-section of a hydraulic cylinder with a concave base region;

FIG. 4 A partial cross-section of an hydraulic cylinder with a convex base region;

FIG. 5 A first embodiment of the inventive hydraulic cylinder in which the eye part and split mounting bolt is arranged outside the cylinder container;

FIG. 6 A second embodiment of the inventive hydraulic cylinder in which the eye part and split mounting bolt are arranged outside the cylinder container;

FIG. 7 Embodiments of the inventive hydraulic cylinder in accordance with FIGS. 5 and 6, but with continuous mounting pins;

FIG. 8 A further embodiment of the inventive hydraulic cylinder with narrow eye part and pivot bearing;

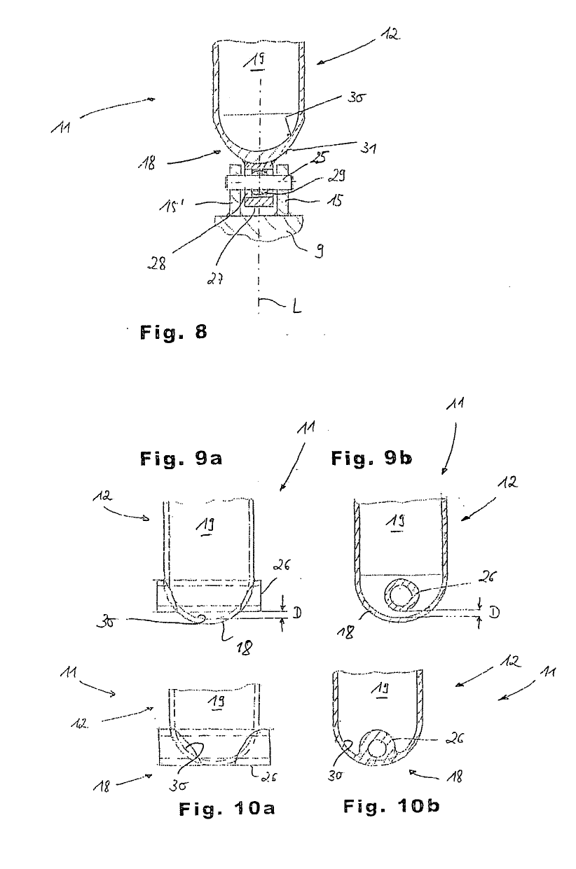

FIGS. 9a, b A first embodiment of the inventive hydraulic cylinder with a bolt housing which penetrates the cylinder container;

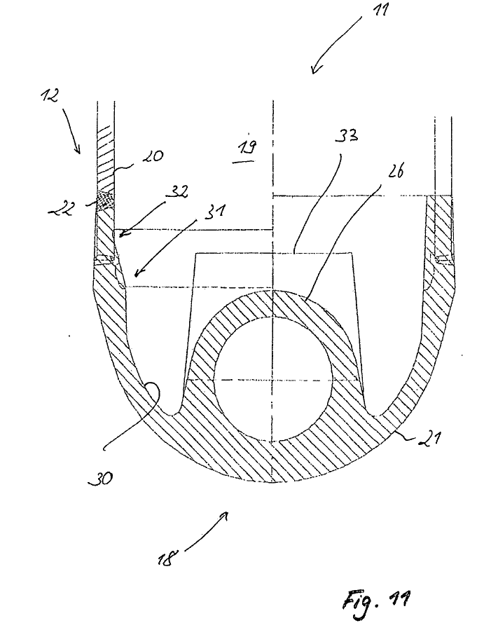

FIGS. 10a, b A further embodiment of the inventive hydraulic cylinder with a bolt housing which penetrates the cylinder container;

FIG. 11 A detailed view of the hydraulic cylinder in accordance FIGS. 10a, b, and

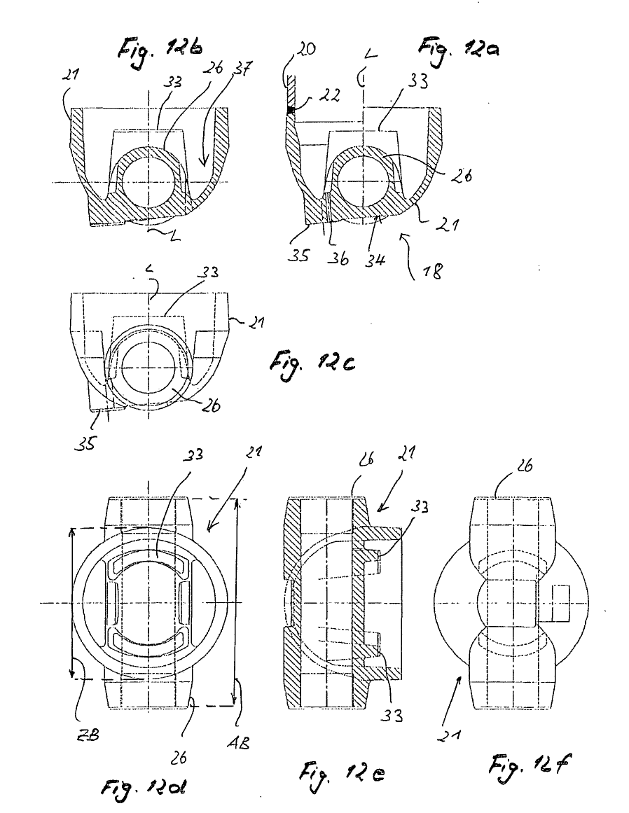

FIGS. 12 a-f Detailed views—some in cross-section—of a further embodiment of the inventive hydraulic cylinder.

FIG. 1 shows an inventive device 1 with mast superstructure 2 in the form of an self-propelled concrete pump. The device 1 has a truck chassis 3 with a cab 4 and a chassis carrier 5, on which is arranged a slewing gear 6 for the mast superstructure 2. The mast superstructure 2 itself has a series of mast arms connected in an articulated manner, a fact which will be explained with the aid of FIG. 2 below. In accordance with the embodiment shown, chassis 3 bears an assembled concrete pump, not shown in detail, whose filling hopper 7 through which the concrete pump is charged by a mixer, not shown, is located at the rear of the vehicle. At the mast superstructure 2 is furthermore provided a conveying device, not shown, for the concrete delivered by the concrete pump, so that the concrete can be conveyed anywhere along the mast superstructure within reach of the deployed mast superstructure 2.

FIG. 2 shows a detailed schematic view of the mast superstructure 2 from FIG. 1 in the deployed state. The mast superstructure 2 has at least two mast arms 9, 10 interconnected by a joint 8, of which one 10 may be pivoted relative to the other mast arm 9 by a hydraulic cylinder 11. In the known manner, the hydraulic cylinder 11 has for this purpose an essentially tubular cylinder container 12, in which a sliding piston 13 is accommodated. The cylinder container 12 of the hydraulic cylinder 11 is hinged at a first joint point 14 on a bearing part 15 of the first mast arm 9, while the piston 13 of the hydraulic cylinder 11 is mounted to a joint point 17 of the second mast arm 10 via a piston rod 16.

FIG. 3 shows a partial cross-section of a hydraulic cylinder 11 of the present invention. Portrayed is the cylinder container 12 of a hydraulic cylinder 11, the base region 18 of which, in accordance with the embodiment shown, is closed on one side, with the base region 18, in the manner of a hemisphere, configured so as to be concave with respect to the inside 19 of the cylinder container 12, i.e. is curved outwardly. In the embodiment of FIG. 3, the cylinder container 12 is formed in two pieces from a cylindrical pipe 20 and a hemispherical base piece 21, which are connected by a weld seam 22. Alternatively, the cylinder container 12 can, of course, also be configured as one piece, especially as a cast part.

In accordance with the embodiment of the inventive hydraulic cylinder shown in FIG. 4, the cylinder container 12 is in turn formed from a cylinder pipe 20 and a welded-on base piece 21, with the base piece 21 being arranged such that, with respect to the interior 19 of the cylinder container 12, it forms a convex, i.e. inwardly curved, base piece 18.

In accordance with FIG. 2, the cylinder container 12 of the inventive hydraulic cylinder 11 is hinged at a first mast arm 9 of the mast arm arrangement 2. FIG. 5 shows a corresponding inventive embodiment of the cylinder container 12 shown in FIG. 3, in which the cylinder container 12 is extended beyond the curved base region 18 by means of a ring-shaped eye part 23. The eye part 23 has in its casing two diametrically opposed eye openings 24, 24′, through each of which is fed a short mounting bolt 25 or 25′, which interacts with the pairs of bearing elements 15, 15′ provided at the mast arm for the purpose of mounting the hydraulic cylinder 11 to the mast arm 9 in an articulated manner. In accordance with a preferred embodiment, the ring-shaped eye part 23 is connected to the cylinder container 12 by welding (weld seam 22).

FIG. 6 shows a corresponding further development of the inventive hydraulic cylinder 11 of FIG. 4. In contrast to the embodiment of the above-described FIG. 5, no additional eye part 23 is provided in FIG. 6, but rather the base piece 21 of the cylinder container 12 is extended downwards, that is, at its open end, and so takes on the function of the ring-shaped eye part 23 as shown in FIG. 5. Accordingly, in accordance with FIG. 6, the base piece 21 has diametrically opposed eye openings 24, 24′, into each of which a short mounting bolt 25, 25′ is introduced. As in the illustration in FIG. 5, the mounting pins 25, 25′ again interact with pairs of bearing elements 15, 15′, which are provided at the mast arm 9 in accordance with FIG. 2.

In this regard, the left side of FIG. 7 shows a further development of the object of FIG. 5 in which, instead two of short mounting pins, one continuous mounting bolt 25 only is present, which is fed in a continuous bearing-bolt pipe 26 extending between the eye openings 24, 24′ in the manner of a bolt housing. The right side of FIG. 7 shows a corresponding embodiment for a hydraulic cylinder 11 in accordance with FIGS. 4 and 6, i.e. a hydraulic cylinder with a convex base region 18.

FIG. 8 shows a further embodiment of the inventive hydraulic cylinder 11, in which the eye part is configured not as a connecting ring as shown in FIGS. 5 to 7, but rather as a narrow rib 27. To this end, a narrow, rib-shaped eye part 27 is arranged in a vertex of the curvature of the curved base region 18 of the cylinder container 12, preferably welded on. The eye part 27 has a breakthrough 28 perpendicular to a longitudinal axis L of the cylinder container 12, in which break-through is provided a pivot bearing 29. The pivot bearing 29 has a continuous mounting bolt 25, which in turn interacts with suitable bearing elements 15, 15′ on the first mast arm 9 of the multiple part mast superstructure 2 (FIGS. 1, 2). For stability reasons, the inside of the base region 18 of the cylinder container 12, i.e. the side facing the interior wall 19 of the cylinder container 12, has a uniform hemispherical curvature and, the outside 31, i.e. the side facing away from the interior wall 19 of the cylinder container, has a non-uniform, specifically parabolic, curvature. This leads to a slight thickening of the base region 18 of the cylinder container 12 in the vertex of the curvature, in which is arranged—as already mentioned—the rib-shaped eye part 27.

By way of alternative to the above-described embodiments of the inventive hydraulic cylinder with the eye arranged inside the cylinder container, the following FIGS. 9 to 11 show embodiments of the inventive hydraulic cylinder 11, in which the mounting bolt 25 or the bearing-bolt pipe 26 (cf. FIG. 7) penetrate the interior 19 of the cylinder container 12.

FIGS. 9a, b show a cylinder container 12 of an inventive hydraulic cylinder 11 with outwardly curved hemispherical base region 18 (see FIG. 3), in which a bearing-bolt pipe 26 for a mounting pin, not shown, penetrates the interior 19 of the cylinder container 12 in an area which is defined (bounded) by the curved base region 18 of the cylinder container 12. The cylinder container 12 and the bearing-bolt pipe 26 can be configured as one piece (e.g. as a cast part). Alternatively, a two-piece embodiment of the cylinder container 12 in accordance with FIG. 3 is possible, with only the base piece 21 (FIG. 3) and the bearing-bolt pipe 26 configured as a one-piece cast part. Finally, however, a further embodiment is possible, in which the cylinder container 12 or its base piece 21 (FIG. 3) is opened on two sides, such that the bearing-bolt pipe 26 can be fed as a separate component through the cylinder container 12 and can be welded to it. In this connection, in accordance with FIGS. 9a, b the bearing-bolt pipe 26 is arranged at a certain minimum distance D from the inner wall 30 in the base region 18 of the cylinder container 12. In the embodiment shown, the bearing-bolt pipe 26 has a circular cross-section, such as, for example, may be seen in FIG. 9b, but the invention is not determined therein. The bearing-bolt pipe 26 can instead have a noncircular cross-section, such as rectangular, square, triangular or elliptical cross-section. Although in the embodiments shown in FIGS. 9b and 10b, the center point of the bearing-bolt pipe 26 is arranged on the longitudinal axis L of the cylinder container, other configurations are also possible. For example, in a further advantageous embodiment, the center point of the bearing-bolt pipe may be laterally offset at a distance from the longitudinal axis L.

Alternatively, FIGS. 10a, b show an embodiment of the inventive hydraulic cylinder 11, in which the bearing-bolt pipe 26 touches the base region 18 of the inner wall 30 of the cylinder container 12. Preferably, in the course of this embodiment, at least the base piece 21 (FIG. 3) of the cylinder container 12 and the bearing-bolt pipe 26 are configured jointly as one piece (e.g. as a cast part).

Such a structure of the inventive hydraulic cylinder 11 is shown in detail in FIG. 11, again with the aid of a partial cross-section. In accordance with FIG. 11, the cylinder container 12 is composed of two pieces comprising a cylindrical pipe 20 and a base piece 21, preferably welded (weld seam 22), with the base piece 21 of the cylinder container 12 having, for stability reasons, a bulge in an area 31 towards the open end and, in a further area 32, a recess on its inside 27. Furthermore, the cross-section of the bearing-bolt pipe 26 has a trapezoidal extension pointing upwards, i.e. towards the cylinder interior 19, such that a stop is created for the moveable piston 13 (FIG. 2) inside the cylinder container, with the stop 33 preferably being at the level of the recess 32. The right part of FIG. 11 also shows a cast contour of the base piece 21 prior to machining for the purpose of configuring the bulge 31 or the recess 32.

FIGS. 12a-f show details of a further embodiment of a base piece 21 of an inventive hydraulic cylinder 11 (cf. FIG. 3) using a number of different (cross-sectional) views.

The right part of FIG. 12a, again, shows a cast piece contour of the base piece 21 of an inventive hydraulic cylinder in cross-section. The left part of FIG. 12a shows an embodiment, essentially corresponding to that of FIG. 11, of the base piece 21 with attached cylinder pipe 20 after machining of the cast piece contour (cf. FIG. 11). In this connection, the vertex area of the curvature of base piece 21 has an inclined flattening 34 to which—offset in the radial direction with regard to the longitudinal axis L of the base piece 21—is attached a shoulder 35 with a bore hole 36. Shoulder 35 serves as a specially machined planar surface for accommodating a hydraulic valve that can be connected to the bore hole 36.

FIG. 12b shows a cross-section along the line A-A (see FIG. 12d). This illustration shows, especially in an area 37 of the curved base region 18, a decreasing radius of curvature R of the curved base region 18 from the outside towards the longitudinal axis L of the base piece 21.

FIGS. 12c and 12d show a side view and a plan view of the base piece 21 in accordance with FIGS. 12a, b, wherein FIG. 12d, especially, shows a curvature of the stop 33 configured as a two-part projection, that nearly parallels the, in plan view, circular outer contour of the base piece 21 (cf. also FIG. 12e).

Finally, FIGS. 12e and 12f show a cross-section in accordance with line FIG. B-B in FIG. 12d and a view of the base piece 21 from below (arrow X in FIG. 12 e).

As FIGS. 12d-f especially show, the inventive shoulder, with a penetration of the volume defined by the curved base region 18 of the cylinder container 12, offers the possibility of varying the eye width AB (FIG. 12d) relative to a width ZB (FIG. 12d) of the cylinder container 12 to relatively far beyond the last-mentioned width ZB, with the increase in width (AB-ZB) being limited solely by the flexural strength of the structure.

1. A concrete-pumping vehicle with a concrete pump and a multiple part mast superstructure comprising at least two mast arms connected in an articulated manner, of which one may be pivoted relative to the other mast arm, wherein the hydraulic cylinder has a cylinder container for accommodating a priston, said container being closed on one side and being located in a base region, characterized by the fact that the base region of the cylinder container has a curved configuration.

2. The concrete-pumping vehicle in accordance with claim 1, wherein the base region is formed so as to be convex with respect to the cylinder container.

3. The concrete-pumping vehicle in accordance with claim 1, wherein the base region is formed so as to be concave with respect to the cylinder container.

4. The concrete-pumping vehicle in accordance with claim 1, wherein the base region has a uniform curvature in its cross-section.

5. The concrete-pumping vehicle in accordance with claim 1, wherein the base region is configured as a spherical segment, especially a hemispherical shell.

6. The concrete-pumping vehicle in accordance with claim 1, wherein the base region has a non-uniform curvature in its cross-section.

7. The concrete-pumping vehicle in accordance with claim 6, wherein the base region is configured as a paraboloid.

8. The concrete-pumping vehicle in accordance with claim 1, wherein the base region is configured so as to be symmetrical in cross-section with respect to a longitudinal axis of the cylinder container.

9. The concrete-pumping vehicle in accordance with claim 1, wherein the base region has different curvatures on its inside and outside with respect to the cylinder container.

10. The concrete-pumping vehicle in accordance with claim 1, wherein the inside of the base region is configured so as to be a spherical segment, especially a hemisphere, and the outside as a paraboloid.

11. The concrete-pumping vehicle in accordance with claim 1, wherein an eye part for mounting the hydraulic cylinder to one of the mast arms is arranged at the base region.

12. The concrete-pumping vehicle in accordance with claim 11, wherein the eye part is formed as a narrow rib with swing bearing.

13. The concrete-pumping vehicle in accordance with claim 11, wherein the eye part is configured as a ring part extending the cylinder container beyond the base region, the casing of said ring part having two opposing eye openings for accommodating at least one mounting bolt.

14. The concrete-pumping vehicle in accordance with claim 11, wherein the eye part is configured as a bearing-bolt pipe pushed through the cylinder container.

15. The concrete-pumping vehicle in accordance with claim 14, wherein the bearing-bolt pipe is arranged within a volume defined by the base region.

16. The concrete-pumping vehicle in accordance with claim 14, wherein the bearing-bolt pipe touches the base region.

17. The concrete-pumping vehicle in accordance with claim 14, wherein the bearing-bolt pipe is arranged at a distance from the base region.

18. The hydraulic cylinder in accordance with claim 14, wherein the base region and the bearing-bolt pipe are configured as one piece.

19. The concrete-pumping vehicle in accordance with claim 14, wherein a stop for the piston is provided at the bearing-bolt pipe.

20. The concrete-pumping vehicle in accordance with claim 1, wherein at least one component, such as a non-return valve block, which is sensitive to mechanical stresses, is integrated into the base region.
